(19) United States
(12) Patent Application Publication
(10) Pub. No.: US 2025/0094874 A1
(43) Pub. Date: Mar. 20, 2025

(54) INFORMATION PROCESSING DEVICE AND METHOD

(71) Applicant: Kioxia Corporation, Tokyo (JP)

(72) Inventors: Daiki KOYAMA, Yokohama Kanagawa (JP); Yusuke UMEZAWA, Yokohama Kanagawa (JP)

(73) Assignee: Kioxia Corporation, Tokyo (JP)

(21) Appl. No.: 18/829,957

(22) Filed: Sep. 10, 2024

(30) Foreign Application Priority Data
Sep. 20, 2023 (JP) 2023-152257

(51) Int. Cl. G06N 20/00

(52) U.S. Cl. CPC G06N 20/00

(57) ABSTRACT

According to an embodiment, a first data set is a set of inspection results for chips formed on a wafer or cut out from the wafer. The inspection results are obtained by executing a first inspection on the chips. A second data set indicates, for each chip, presence or absence of early failure obtained by executing a second inspection on the chips. A processor determines, based on the first data set, a cluster of chips not satisfying a first criterion. The processor calculates a third data set being a set of feature amounts of chips related to a distance to the cluster. The processor executes training of a machine learning model by using, as input data, the first data set and the third data set and using the second data set as correct answer data. The processor outputs the machine learning model of which the training has been executed.

### CROSS-REFERENCE TO RELATED APPLICATIONS

This application is based upon and claims the benefit of priority from Japanese Patent Application No. 2023-152257, filed on Sep. 20, 2023, the entire contents of which are incorporated herein by reference.

### FIELD

Embodiments described herein relate generally to an information processing device and a method.

### BACKGROUND

As one of defects of a semiconductor integrated circuit, early failure is known. Early failure is one of failures that occur after shipment of a product and is a failure that occurs with a significantly smaller number of times of use than the service life.

In manufacturing a chip of a semiconductor integrated circuit, it is desired to accurately estimate whether or not each of chips formed on a wafer or each of chips cut out from the wafer has early failure.

### BRIEF DESCRIPTION OF THE DRAWINGS

FIG. 1 is a diagram illustrating an example of a configuration of an information processing device according to an embodiment;

FIG. 2 is a diagram illustrating an example of an operation of calculating a peripheral feature amount set executed by the information processing device according to the embodiment;

FIG. 3 is another diagram illustrating an example of the operation of calculating the peripheral feature amount set executed by the information processing device according to the embodiment;

FIG. 4 is a diagram illustrating an example of an operation of determining a defective cluster executed by the information processing device according to the embodiment;

FIG. 5 is a table illustrating an example of data used for training of early failure estimation model according to an embodiment;

FIG. 6 is a diagram illustrating a method of using the early failure estimation model according to the embodiment that has been leaned;

FIG. 7 is a flowchart illustrating an example of an operation of generating the early failure estimation model according to the embodiment;

FIG. 8 is a flowchart illustrating an example of a score calculation operation according to the embodiment;

FIG. 9 is a table for describing a specific example of a determining method of a second item according to the embodiment;

FIG. 10 is a flowchart illustrating an example of an operation of estimating a chip CP with early failure according to the embodiment;

FIG. 11 is a diagram for describing an averaging operation on an inspection data set according to a modification; and

FIG. 12 is a diagram illustrating an example of processing on the peripheral feature amount set according to the modification.

### DETAILED DESCRIPTION

According to the present embodiment, an information processing device includes a processor. The processor is configured to acquire a first data set and a second data set. The first data set is a set of inspection results for multiple chips formed on a wafer or cut out from the wafer. The inspection results are obtained by executing a first inspection on the multiple chips. The second data set indicates, for each of the multiple chips, presence or absence of early failure obtained by executing a second inspection on the multiple chips. The processor is configured to determine, based on the first data set, a cluster of chips not satisfying a first criterion out of the multiple chips. The processor is configured to calculate a third data set being a set of feature amounts of chips related to a distance to the cluster. The processor is configured to execute training of a machine learning model by using, as input data, the first data set and the third data set and using the second data set as correct answer data. The processor is configured to output the machine learning model of which the training has been executed.

The information processing device according to the embodiment has, as two major functions, a function of generating early failure estimation model and a function of estimating a chip with early failure by using the early failure estimation model. The early failure estimation model is a trained machine learning model that outputs numerical information indicating the probability of whether or not a chip has early failure.

The information processing device according to the embodiment may be configured as a computer as an inspection device that performs inspection on a wafer or a chip or may be configured as a device (for example, a server) different from the inspection device. The function of generating the early failure estimation model and the function of estimating a chip with early failure by using the early failure estimation model may be implemented in different computers. For example, the function of generating the early failure estimation model may be implemented in a server, and the function of estimating a chip with early failure by using the early failure estimation model may be implemented in a computer as the inspection device.

As described above, the two functions of the information processing device according to the embodiment can be implemented in various computers. Description will be given herein on the premise that, as an example, the two functions are implemented in one computer.

Hereinafter, an information processing device and a method according to an embodiment will be described in detail by referring to the accompanying drawings.

Note that the present invention is not limited by the embodiment.

### Embodiment

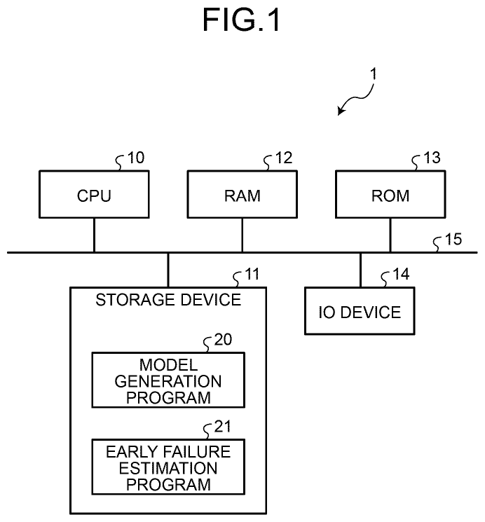

FIG. 1 is a diagram illustrating an example of the configuration of an information processing device according to an embodiment.

An information processing device 1 includes a central processing unit (CPU) 10, a storage device 11, a random access memory (RAM) 12, a read only memory (ROM) 13, an input and output (IO) device 14, and a bus 15. The CPU 10, the storage device 11, the RAM12, the ROM13, and the IO device 14 are electrically connected to the bus 15.

Note that the information processing device 1 may further include a human machine interface (HMI) or the like for an operator to operate the information processing device 1.

The CPU 10 is a processor that executes a computer program.

The IO device 14 is an interface for the information processing device 1 to execute data transfer to and from an external device. The IO device 14 may be an interface device capable of wireless data transfer or an interface capable of data transfer via a wired communication path.

The RAM12 is a volatile memory that operates at a higher speed than that of the ROM13 or the storage device 11. The RAM12 provides the CPU 10 with an area as cache or a buffer.

The ROM13 and the storage device 11 are memories capable of storing information such as data or a computer program in a nonvolatile manner. The storage device 11 can store more information than the ROM13 can. The storage device 11 can be configured by, for example, a hard disk drive (HDD), a solid state drive (SSD), or a combination thereof.

Note that the storage device 11 may be provided outside the information processing device 1, and the information processing device 1 and the storage device 11 may be connected via a network or the like. The storage device 11 may be a detachable device such as a universal serial bus (USB) memory, a secure digital (SD) card, or an external HDD.

The storage device 11 stores a model generation program 20 and early failure estimation program 21. The model generation program 20 is a computer program for implementing a function of generating early failure estimation model. The early failure estimation program 21 is a computer program for implementing a function of estimating a chip with early failure by using the early failure estimation model. The CPU 10 loads these computer programs from the storage device 11 to the RAM12. The CPU 10 executes these computer programs loaded in the RAM12 to implement the respective functions.

In generating the early failure estimation model, the information processing device 1 uses one or more inspection data sets and early failure label set.

Each inspection data set is a set of inspection results (referred to as inspection data) for each chip obtained by first inspection. Each inspection data set includes inspection data for multiple chips included in one wafer.

The first inspection is performed before shipment of the wafer or the chips. The first inspection may be performed on multiple chips formed on the wafer or may be performed on multiple chips cut out from the wafer. Note that, it is based on the premise that each piece of inspection data is associated with position information on the wafer of the chip from which the inspection data is obtained.

The first inspection may include inspection of multiple items. In a case where each chip is a memory chip, the inspection of the items in the first inspection may include, for example, inspection with a neutral threshold value, inspection of a leakage current after stress is applied between electrodes, inspection of the number of memory blocks whose characteristic values do not satisfy a criteria, and the like. Note that the neutral threshold value is a value of the threshold voltage of a memory cell transistor on which neither writing nor reading has been performed yet.

The early failure label set is a set of inspection data for each chip obtained by second inspection. The early failure label set includes inspection data for all chips included in one wafer.

The second inspection is an inspection for determining the presence or absence of early failure. The inspection data by the second inspection is binary data indicating whether or not there is early failure. The inspection data by the second inspection is referred to as early failure label.

In a case where each chip is a memory chip, the second inspection is performed by executing multiple times a cycle of programming data and erasing data and then executing a test as to whether or not data can be normally read. A chip from which data cannot be normally read is determined to have early failure. A chip from which data can be normally read is determined not to have early failure.

The wafer or chips on which the second inspection has been performed has degraded in performance compared to the chips in the state immediately before the second inspection. Therefore, the wafer or chips on which the second inspection has been performed are not suitable for shipment. If the second inspection is performed on all the chips, the presence or absence of early failure is found for all the chips. However, the chips subjected to the second inspection cannot be shipped. Therefore, it is desired to accurately estimate the presence or absence of early failure without performing the second inspection.

The early failure estimation model is a model for calculating an occurrence probability of early failure without requiring a result of the second inspection. In order to enable such determination, the early failure label obtained by the second inspection is used as correct answer data at the time of training.

In a case where defective chips are densely located on a wafer, there is a tendency that early failure is highly likely to occur in a chip adjacent to the group of densely located defective chips. Therefore, the information processing device 1 calculates, for each chip, a peripheral feature amount that is a feature amount related to the distance to the group of defective chips. Then, a peripheral feature amount set including the peripheral feature amounts of all the chips included in one wafer is used for determination of early failure.

Note that, in the present specification, a defective chip refers to a chip whose inspection data of an inspection item is worse than a criterion for a non-defective chip. Although details will be described later, the information processing device 1 autonomously determines the criterion for a non-defective chip. Therefore, the defective chip does not have to be synonymous with a chip not satisfying an inspection criterion for shipment availability.

The group of defective chips is determined by clustering. Therefore, hereinafter, the group of defective chips is referred to as a defective cluster. Details of a method for determining a defective cluster by clustering will also be described later.

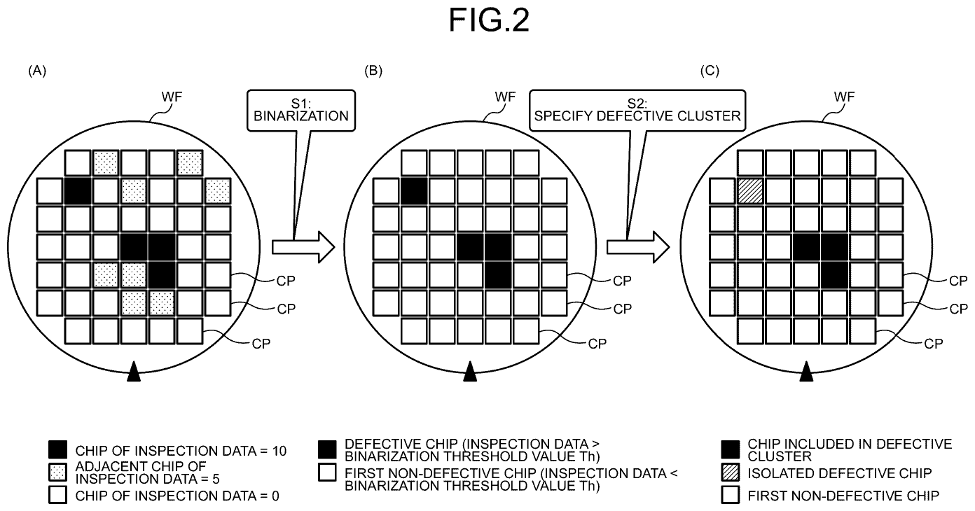

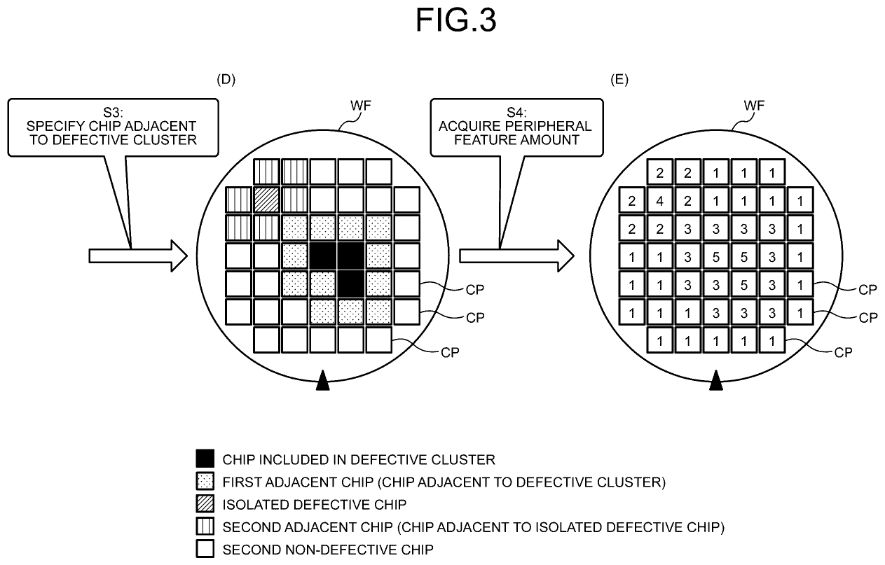

FIGS. 2 and 3 are diagrams illustrating an example of the operation of calculating a peripheral feature amount set executed by the information processing device 1 according to the embodiment.

In part (A) of FIG. 2, a plurality of chips CP formed on a wafer WF is depicted. Each of the chips CP is hatched on the basis of inspection data obtained by the first inspection of an item. In order to simplify the description, it is based on the premise that the inspection data can take 0, 5, or 10. A dark-colored chip CP is a chip CP with an inspection data of 10. A dot-hatched chip CP is a chip CP with an inspection data of 5. An outlined chip CP is a chip CP with an inspection data of 0.

The information processing device 1 classifies these chips CP into a group of defective chips and a group of first non-defective chips by performing binarization using a binarization threshold value Th (S1).

In step S1, the information processing device 1 determines, as a defective chip, a chip CP whose inspection data does not satisfy the criterion for a non-defective chip. The inspection data of the first non-defective chip satisfies the criterion for a non-defective chip. The binarization threshold value Th is a threshold value that defines the criterion for a non-defective chip.

Which of a chip CP having inspection data larger than the binarization threshold value Th and a chip CP having inspection data smaller than the binarization threshold value Th is determined as a defective chip depends on the type of the inspection data.

In the case of inspection data of a type indicating a worse state as the value is larger, the information processing device 1 classifies a chip CP whose inspection data is larger than the binarization threshold value Th as a defective chip and classifies a chip CP whose inspection data is smaller than the binarization threshold value Th as a first non-defective chip. In the case of inspection data of a type indicating a worse state as the value is smaller, the information processing device 1 classifies a chip CP whose inspection data is larger than the binarization threshold value Th as a first non-defective chip and classifies a chip CP whose inspection data is smaller than the binarization threshold value Th as a defective chip.

The information processing device 1 may classify a chip CP whose inspection data is equal to the binarization threshold value Th as a first non-defective chip or as a defective chip.

Part (B) of FIG. 2 illustrates a result of classification by the binarization threshold value Th. A dark-colored chip CP is classified as a defective chip. An outlined chip CP is classified as a first non-defective chip. Note that, it is based on the premise herein that the inspection data is of a type indicating a worse state as the value is larger. Therefore, a chip CP whose inspection data is larger than the binarization threshold value Th is classified as a defective chip, and a chip CP whose inspection data is smaller than the binarization threshold value Th is classified as a first non-defective chip.

Subsequently, the information processing device 1 determines a defective cluster by clustering (S2).

In part (C) of FIG. 2, the dark-colored chips CP constitute a defective cluster. An obliquely hatched chip CP is a defective chip that does not constitute the defective cluster. The defective chip not constituting the defective cluster is referred to as an isolated defective chip.

The description will be made with reference to FIG. 3. After determining the defective cluster, the information processing device 1 determines chips CP adjacent to the defective cluster from among the first non-defective chips (S3).

Part (D) of FIG. 3 illustrates a result of determining the chips CP adjacent to the defective cluster. The dark-colored chips CP constitute the defective cluster. Dot-hatched chips CP are adjacent to the defective cluster.

In the example illustrated in part (D) of FIG. 3, a state of being adjacent to the defective cluster means a state of contacting with any of the chips CP constituting the defective cluster at a side or a corner. The definition of being adjacent to a defective cluster is not limited to the above. In one example, a first non-defective chip that contacts with any one of the chips CP constituting the defective cluster at a side or a corner via a predetermined number of chips CP may be determined as a chip CP adjacent to the defective cluster. In other words, a chip CP having a short distance to the defective cluster is determined as a chip CP adjacent to the defective cluster.

Note that, in the example illustrated in part (D) of FIG. 3, not only the chips CP adjacent to the defective cluster but also chip CP adjacent to the isolated defective chip are determined. This is because it is conceived that the probability of occurrence of early failure is higher in second adjacent chips than in second non-defective chips although it is not as high as in the first adjacent chips. The chips CP hatched with vertical lines are adjacent to the isolated defective chip.

Hereinafter, a chip CP adjacent to a defective cluster is referred to as a first adjacent chip. A chip CP adjacent to an isolated defective chip is referred to as a second adjacent chip. A chip CP that does not correspond to any of the defective chips, the first adjacent chips, and the second adjacent chips is referred to as a second non-defective chip.

Subsequently, as illustrated in part (E) of FIG. 3, the information processing device 1 acquires the peripheral feature amount of each chip CP. The information processing device 1 assigns “5” as the peripheral feature amount to the chips CP constituting the defective cluster. The information processing device 1 assigns “4” as the peripheral feature amount to the isolated defective chip. The information processing device 1 assigns “3” as the peripheral feature amount to the first adjacent chips. The information processing device 1 assigns “2” as the peripheral feature amount to the second adjacent chips. The information processing device 1 assigns “1” to the second non-defective chips.

Note that it is optional to determine the second adjacent chips. It is optional to differentiate the value of the peripheral feature amount between the second non-defective chips and the second adjacent chips. It is optional to differentiate the value of the peripheral feature amount between the isolated defective chip and the chips CP constituting the defective cluster. As long as different values are assigned to chips CP depending on the distance to a defective cluster as the peripheral feature amount, the manner of assigning the peripheral feature amount can be variously modified.

Hereinafter, a chip CP that is neither a defective chip nor a first adjacent chip is referred to as a third non-defective chip. In the example illustrated in FIG. 3, the third non-defective chip is a second adjacent chip or a second non-defective chip.

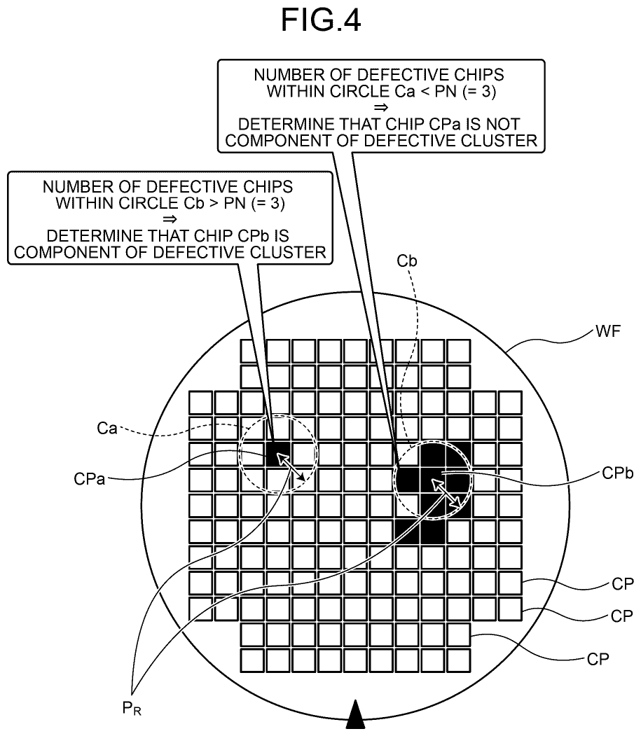

FIG. 4 is a diagram illustrating an example of an operation of determining a defective cluster executed by the information processing device 1 according to the embodiment.

As described above, a defective cluster is determined by clustering. As a clustering algorithm, an algorithm that is capable of adjusting a cluster determining result by parameters is used. As an example of an algorithm capable of adjusting a determining result of a defective cluster by parameters, the information processing device 1 uses an algorithm called density-based spatial clustering of applications with noise (DBSCAN) to determine a defective cluster.

In DBSCAN, two parameters are used. The two parameters are denoted to as parameters P_{N} and P_{R}.

The information processing device 1 selects one defective chip and sets a circle having a radius P_{R} centered on the selected defective chip. Then, the information processing device 1 counts the number of defective chips included in the set circle. In a case where the number of defective chips included in the set circle is less than P_{N}, the information processing device 1 does not recognize the selected defective chips as components of a defective cluster. In a case where the number of defective chips included in the set circle is larger than P_{N}, the information processing device 1 recognizes the selected defective chips as components of a defective cluster.

In the example illustrated in FIG. 4, the number of defective chips included in a circle Ca centered on a defective chip CPa is one. For example, in a case where P_{N} is “3”, the number of defective chips included in the circle Ca is smaller than P_{N}. In this case, the defective chip CPa is determined not to be a component of a defective cluster. Note that all the defective chips within a circle having a radius P_{R} centered on a defective chip, which is already determined to be a component of a defective cluster, are deemed to belong to the defective cluster even if the number of defective chips within this circle is smaller than P_{N}.

In FIG. 4, the number of defective chips included in a circle Cb centered on another defective chip CPb is five. Since the number of defective chips included in the circle Cb is larger than P_{N} (“3”), the defective chip CPb is determined to be a component of a defective cluster.

The information processing device 1 performs, for each defective chip on one wafer WF, the selection of a defective chip, the setting of a circle, and the determination based on the number of defective chips included in the circle. As a result, a defective cluster is determined. A defective chip that is not a component of a defective cluster is determined as an isolated defective chip.

Note that, according to DBSCAN, for example, in a case where the value of P_{N} is “1”, the chip can be determined as a cluster even when the number of elements is “1”. In addition, as long as more than P_{N} defective chips are included in a circle having the radius P_{R}, even when those defective chips constitute two or more groups separated from each other, the groups of defective chips can be determined as one cluster. Thus, in the embodiment, a defective cluster may be constituted by one defective chip, and a defective cluster may be constituted by two or more groups of defective chips separated from each other.

The clustering algorithm that can be applied for determining a defective cluster is not limited to the above-described DBSCAN. Any algorithm can be applied as long as a group of dense defective chips can be determined. Even an algorithm that does not use a parameter can be applied. However, in a case where an algorithm that does not use a parameter is applied, parameter optimization described later is not performed for the algorithm.

The information processing device 1 executes training of the early failure estimation model by using the inspection data set and the peripheral feature amount set calculated from the inspection data set.

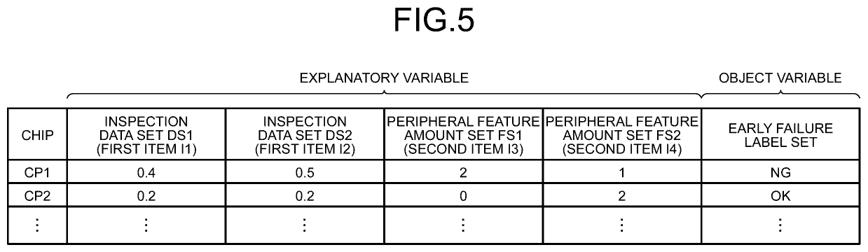

FIG. 5 is a table illustrating an example of data used for training of the early failure estimation model according to the embodiment.

In the example illustrated in FIG. 5, two inspection data sets DS1 and DS2 and two peripheral feature amount sets FS1 and FS2 are used as explanatory variables, and early failure label set is used as an object variable. Accordingly, training is executed for the early failure estimation model such that the two inspection data sets DS1 and DS2 and the two peripheral feature amount sets FS1 and FS2 are used as input data, and the early failure label set is used as correct answer data.

The inspection data set DS1 is obtained by performing the first inspection of item I1. The inspection data set DS2 is obtained by performing the first inspection of item I2. The peripheral feature amount set FS1 is calculated from an inspection data set obtained by the first inspection of item I3. The peripheral feature amount set FS2 is calculated from an inspection data set obtained by the first inspection of item I4. The inspection data sets DS1 and DS2 and the peripheral feature amount sets FS1 and FS2 are obtained from the same wafer WF.

Note that the inspection data sets used for calculation of the peripheral feature amount sets may be inspection data sets used as explanatory variables or may not be inspection data sets used as explanatory variables.

The number of inspection data sets used as explanatory variables may be any number as long as the number is larger than or equal to one. Similarly, the number of peripheral feature amount sets used as explanatory variables may be any number as long as the number is larger than or equal to one.

Hereinafter, an inspection item for obtaining inspection data sets used as the explanatory variables is referred to as a first item. An inspection item for obtaining inspection data sets used for calculation of the peripheral feature amount sets used as the explanatory variables is referred to as a second item. In the example illustrated in FIG. 5, item I1 and item I2 each correspond to the first item. Item I3 and item I4 each correspond to the second item.

By using the early failure estimation model 100 that has been trained and configured as described above, it is possible to accurately estimate a chip CP with early failure.

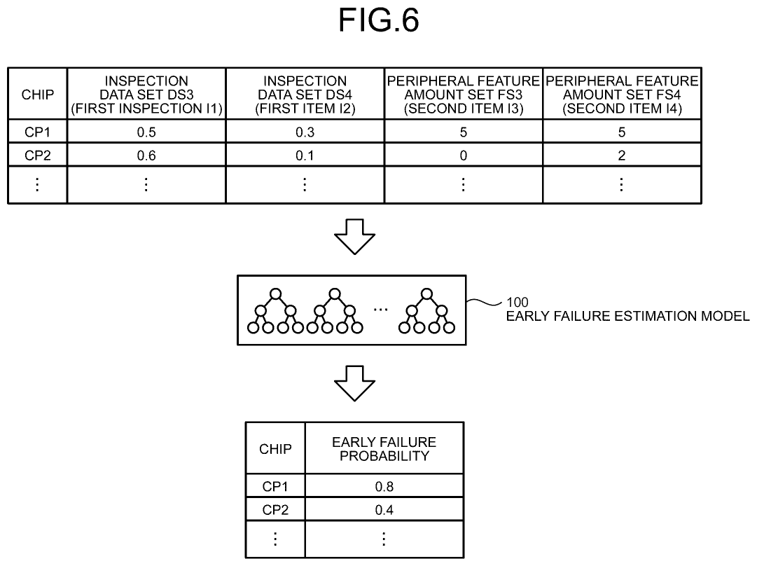

FIG. 6 is a diagram illustrating a method of using the early failure estimation model according to the embodiment that has been leaned. Note that this drawing corresponds to the example illustrated in FIG. 5.

Inspection data sets DS3 and DS4 and peripheral feature amount sets FS3 and FS4 are input to the early failure estimation model 100.

The inspection data set DS3 is obtained by inspection of item I1 on multiple chips CP (denoted as chips CP to be determined) on a wafer WF. The inspection data set DS4 is obtained by inspection of item I2 on the chips CP to be determined. The peripheral feature amount set FS3 is calculated from the inspection data set obtained by inspection of item I3 on the chips CP to be determined. The peripheral feature amount set FS4 is calculated from the inspection data set obtained by inspection of item I4 on the chips CP to be determined.

The early failure estimation model 100 outputs the early failure probability for each of the chips CP to be determined on the basis of the input data. The early failure probability is a probability that the chip CP has early failure.

Note that the early failure probability is numerical value information corresponding to the possibility that the chip CP has early failure. As the numerical value information output by the early failure estimation model 100, numerical value information in any expression other than the probability can be applied as long as the numerical value information corresponds to the possibility that the chip CP has early failure.

Note that, as frequently mentioned above, a peripheral feature amount set, which is a set of feature amounts related to the distance to a defective cluster, is used as one piece of the input data for the early failure estimation model 100. A method of determining a defective cluster or a method of determining a defective chip may affect the accuracy of estimation of a chip CP with early failure.

Therefore, the information processing device 1 is configured to optimize the value of the binarization threshold value Th for determining a defective chip and the parameters P_{N} and P_{R} used for clustering. The optimization refers to setting of each value of the binarization threshold value Th and the parameters P_{N} and P_{R} in such a manner that the estimation accuracy of a chip CP with early failure becomes as high as possible.

In the manufacturing process of wafers or chips, the first inspection of multiple number of items is performed. Selection of inspection data sets used for calculation of the peripheral feature amount sets may also affect the accuracy of estimation of a chip CP with early failure.

Therefore, the information processing device 1 is configured to select an inspection data set that enables most accurate estimation of a chip CP with early failure from a plurality of inspection data sets as the inspection data set for calculation of a peripheral feature amount set.

Details of the method of optimization of each value of the binarization threshold value Th and the parameters P_{N} and P_{R} and the method of selection of inspection data sets for calculation of the peripheral feature amount sets will be clarified in the description of operation.

Hereinafter, the binarization threshold value Th and the parameters P_{N} and P_{R} may be collectively referred to as the parameters Th, P_{N}, and P_{R}. In addition, the accuracy of estimation of a chip CP with early failure is simply referred to as the estimation accuracy.

Next, the operation of the information processing device 1 will be described.

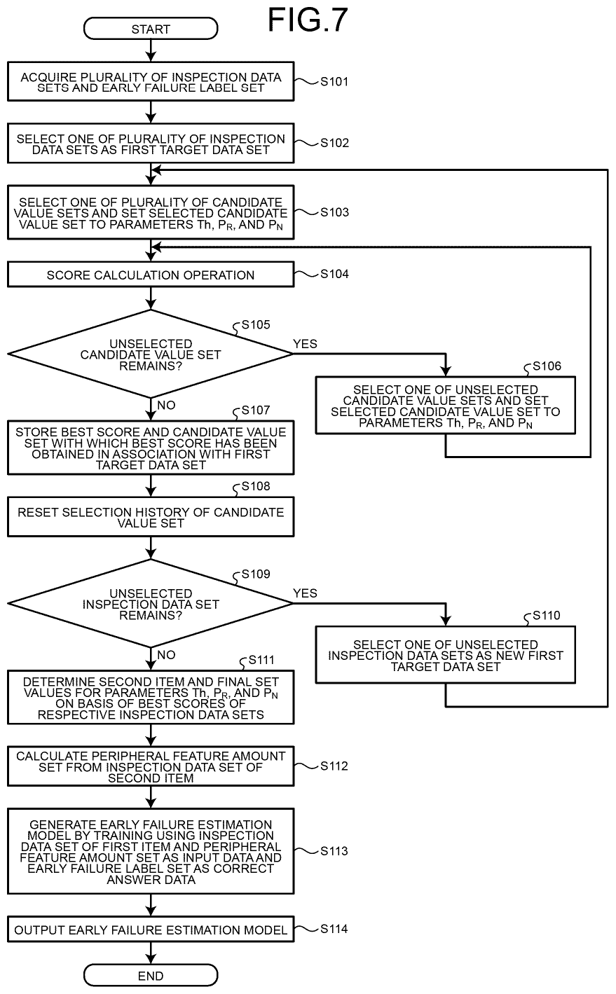

FIG. 7 is a flowchart illustrating an example of an operation of generating the early failure estimation model 100 according to the embodiment. Each piece of processing illustrated in this flowchart is implemented by the CPU 10 executing the model generation program 20.

First, the CPU 10 acquires a plurality of inspection data sets obtained by the first inspection on a plurality of chips CP on a wafer WF and early failure label set obtained by the second inspection on those chips CP on the wafer WF (S101).

The inspection data sets and the early failure label set are stored in, for example, the storage device 11. The CPU 10 may acquire these sets from the storage device 11. Alternatively, the CPU 10 may acquire these sets from an external device (for example, an inspection device or a server) via the IO device 14.

Subsequently, the CPU 10 selects one of the inspection data sets (S102).

After the processing of S102, (i) Optimization of the values of the parameters Th, P_{N}, and P_{R}, and (ii) evaluation of the estimation accuracy in a case where the values of the parameters Th, P_{N}, and P_{R} after optimization are used are executed. The processing of S102 is processing of selecting one inspection data set as a target of the operations (i) and (ii). The inspection data set selected as the target of the operations of (i) and (ii) is referred to as a first target data set. The evaluation value of the estimation accuracy is referred to as a score.

In one example, the score is numerical value information that takes a larger value as the estimation accuracy is higher. A score with a large value means that the estimation accuracy is good, and a score with a small value means that the estimation accuracy is worse. Note that the relationship between the score value and the estimation accuracy is not limited to the above.

In the operation of optimizing the values of the parameters Th, P_{N}, and P_{R}, the score calculation operation of calculating the score is executed multiple times while varying some of or all the parameters Th, P_{N}, and P_{R}. In one example, two or more sets of candidate values for the parameters Th, P_{N}, and P_{R} (referred to as candidate value sets) are prepared in order to differentiate some of or all the parameters Th, P_{N}, and P_{R} of each set for each score calculation operation. In each of the candidate value sets, each candidate value of the candidate value set is determined such that some of or all the parameters Th, P_{N}, and P_{R} are different from any of the other candidate value sets.

The CPU 10 selects one of the candidate value sets and sets the selected candidate value set as the parameters Th, P_{N}, and P_{R} (S103). Subsequently, the CPU 10 executes a score calculation operation (S104).

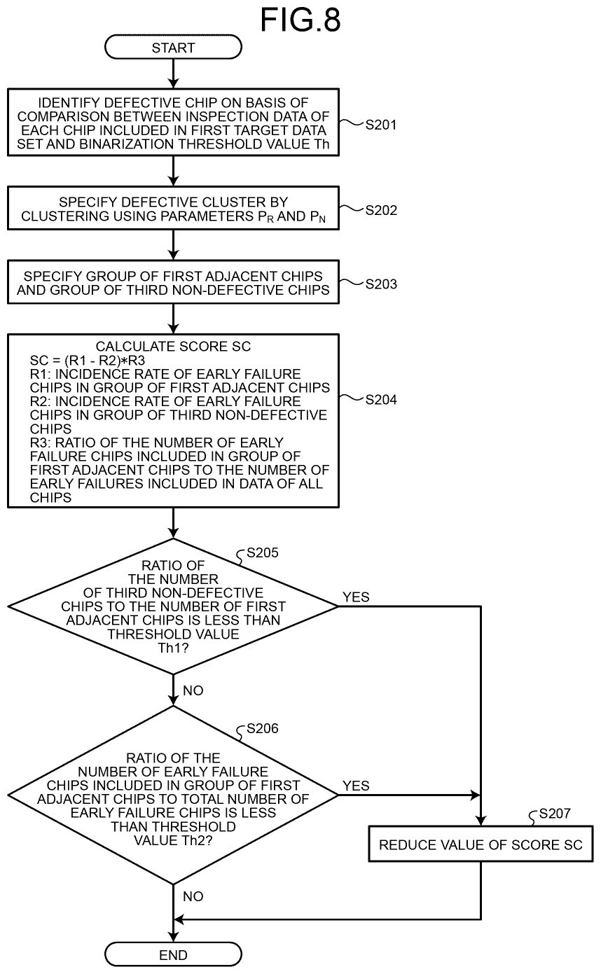

FIG. 8 is a flowchart illustrating an example of the score calculation operation according to the embodiment.

First, the CPU 10 determines a defective chip on the basis of comparison between inspection data of each chip included in the first target data set and the binarization threshold value Th (S201). The CPU 10 executes processing similar to S1 by using a candidate value for the binarization threshold value Th set by the processing of S103.

The CPU 10 determines a defective cluster by clustering using the parameters P_{N} and P_{R} (S202). The CPU 10 executes processing similar to S2 by using candidate values for the parameters P_{N} and P_{R} set by the processing of S103.

The CPU 10 determines a group of first adjacent chips and a group of third non-defective chips on the basis of the defective cluster (S203). The CPU 10 determines the group of first adjacent chips and the group of third non-defective chips by processing similar to the processing of S3. The group of third non-defective chips is a group including second adjacent chips and second non-defective chips. In other words, a third non-defective chip is a chip that is not a defective chip and is not included in the first adjacent chips.

The CPU 10 calculates a score (denoted as a score SC) by using the following Equation (1) (S204). In the present specification, the operator “*” represents an operator of multiplication.

$$SC = ( R 1 - R 2 ) * R 3 \qquad ( 1 )$$

R1 denotes an incidence rate of early failure chip in the group of first adjacent chips. In other words, R1 denotes a ratio of the number of chips CP with early failure included in the group of first adjacent chips to the number of chips CP included in the group of first adjacent chips.

R2 denotes an incidence rate of early failure chip in the group of third non-defective chips. In other words, R2 denotes a ratio of the number of chips CP with early failure included in the group of third non-defective chips to the number of chips CP included in the group of third non-defective chips.

R3 denotes a ratio of the number of chips CP with early failure included in the group of first adjacent chips to the total number of early failure chips.

On the basis of the early failure label set, the CPU 10 determines early failure chip included in the group of first adjacent chips. Then, the CPU 10 obtains R1 by dividing the number of determined early failure chips by the number of chips CP included in the group of first adjacent chips.

The CPU 10 determines early failure chip included in the group of third non-defective chips on the basis of the early failure label set. Then, the CPU 10 obtains R2 by dividing the number of determined early failure chips by the number of chips CP included in the group of third non-defective chips.

The CPU 10 calculates the score SC on the basis of the above-described R1, R2, R3, and Equation (1).

If the group of chips determined to have early failure includes a large number of chips that do not actually have early failure, the yield rate decreases. Contrarily, if a chip actually with early failure is included in the group of chips estimated not to have early failure, shipping the chip having the early failure may lose the customer's trust. Thus, the method of calculating the score SC is designed to consider both yield rate and screening performance.

The part (R1-R2) in the right side of Equation (1) corresponds to the yield rate. The part (R1-R2) with a large value means that the yield rate is high. In the right side of Equation (2), R3 multiplied by (R1-R2) corresponds to the screening performance. R3 with a large value means that the screening performance is high.

Equation (1) is structured such that the score SC is obtained by multiplication of (R1-R2) and R3. The score SC is higher as the yield rate is higher and is higher as the screening performance is higher. Therefore, by optimizing the setting values of the binarization threshold value Th and the parameters P_{N} and P_{R} by using Equation (1), it is possible to determine the setting values of the binarization threshold value Th and the parameters P_{N} and P_{R} in such a manner as to balance a high yield rate and high screening performance with each other.

Note that the method of calculating the score SC is not limited to the above. As long as the score SC is calculated on the basis of the number of early failure chips included in the group of first adjacent chips and the number of early failure chips included in the group of first non-defective chips, the method of calculating the score SC can be modified as desired. For example, the score SC may be obtained by addition of (R1-R2) and R3.

Subsequent to the processing of S204, the CPU 10 determines whether or not the ratio of the number of third non-defective chips to the number of first adjacent chips is less than a predetermined threshold value Th1 (S205).

If the ratio of the number of third non-defective chips to the number of first adjacent chips exceeds the predetermined threshold value Th1 (S205: No), the CPU 10 determines whether or not the ratio of the number of early failure chips included in the group of first adjacent chips to the total number of early failure chips is less than a predetermined threshold value Th2 (S206).

The total number of early failure chips used in the processing of S206 is the total number of early failure chips in all the wafers. In a case where the series of operations illustrated in FIG. 8 is executed for each of one or more wafers, the CPU 10 calculates the total number of early failure chips in the one or more wafers. Then, the CPU 10 uses the total number obtained by the calculation in the determination processing of S206.

The processing of S205 is determination processing executed to prevent the yield rate from being extremely low. Therefore, the threshold value Th1 is set on the basis of the allowable lower limit value of the yield rate.

The processing of S206 is determination processing executed to prevent the screening performance from being extremely low. Therefore, the threshold value Th2 is set on the basis of the allowable lower limit value of the screening performance.

If the ratio of the number of third non-defective chips to the number of first adjacent chips is less than the threshold value Th1 (S205: Yes), or the ratio of the number of early failure chips included in the group of first adjacent chips to the total number of early failure chips is less than the predetermined threshold value Th2 (S206: Yes), the CPU 10 decreases the value of the score SC (S207), and the score calculation operation is ended.

In the processing of S207, the CPU 10 sets the value of the score SC to 0 or a negative value, for example. By significantly lowering the value of the score SC corresponding to a combination of a first target data set and a candidate value set used, this combination is less likely to be applied.

If the ratio of the number of early failure chips included in the group of first adjacent chips to the total number of early failure chips exceeds the threshold value Th2 (S206: Yes), the CPU 10 skips the processing of S207 and ends the score calculation operation.

Note that, as described above, the score SC is numerical information that takes a larger value as the estimation accuracy is higher. Therefore, decreasing of the value of the score SC in S205 and S207 means that the estimation accuracy is deemed to be worse for the sake of convenience. In other words, in S205 and S207, the CPU 10 changes the score SC to a worse value. Therefore, for example, in a case where the score SC is numerical information that takes a smaller value as the estimation accuracy is higher, the CPU 10 increases the value of the score SC in S205 and S207.

The description will be made by referring back to FIG. 7. After the score calculation operation, the CPU 10 stores the score SC in association with the first target data set and the candidate value set used in the score calculation operation. The CPU 10 stores these pieces of information in the RAM12, for example.

The CPU 10 determines whether or not there remain unselected candidate value sets (S105). If there remain unselected candidate value sets (S105: Yes), the CPU 10 selects one of the unselected candidate value sets and sets the selected candidate value set as the parameters Th, P_{N}, and P_{R} (S106). Then, the control transitions to S104.

If no unselected candidate value set remains (S105: No), the CPU 10 stores, in association with the first target data set, the best score among scores obtained by the score calculation operation executed multiple times for the current first target data set, and the candidate value set corresponding to the time when the best score is obtained (S107).

In the example illustrated in FIG. 8, the score is designed to have a larger value as the estimation accuracy is higher. Therefore, in the processing of S107, the CPU 10 stores the highest score and the candidate value set corresponding to the time when the highest score is obtained.

Note that, in the embodiment, in order to determine the best score and the candidate value set from which the best score is obtained, the CPU 10 executes the score calculation operation for all the candidate value sets by loop processing of S103 to S106. The CPU 10 may determine the best score and the candidate value set from which the best score is obtained from some of the candidate value sets by using a method such as Bayesian optimization.

The CPU 10 resets the selection history of candidate value sets (S108). Then, the CPU 10 determines whether or not an unselected inspection data set remains (S109).

If an unselected inspection data set remains (S109: Yes), the CPU 10 selects one of the unselected inspection data sets as a new first target data set (S110). Then, the control transitions to S103.

If no unselected inspection data set remains (S109: No), the CPU 10 determines the second item and the final setting values for the parameters Th, P_{N}, and P_{R} on the basis of the best scores (the highest scores in this example) of respective inspection data sets (S111).

In the processing of S111, the CPU 10 determines an inspection data set having the highest value of the score SC. Then, the CPU 10 determines, as the second item, an item of the first inspection from which the determined inspection data set has been obtained. In addition, the CPU 10 determines a candidate value set associated with the determined inspection data set, as the final setting values for the parameters Th, P_{N}, and P_{R}.

As described above, the number of inspection data sets of the second item is not limited to one. In the processing of S111, a predetermined number of items are determined as second items on the basis of a predetermined number of inspection data sets having the highest value of the score SC.

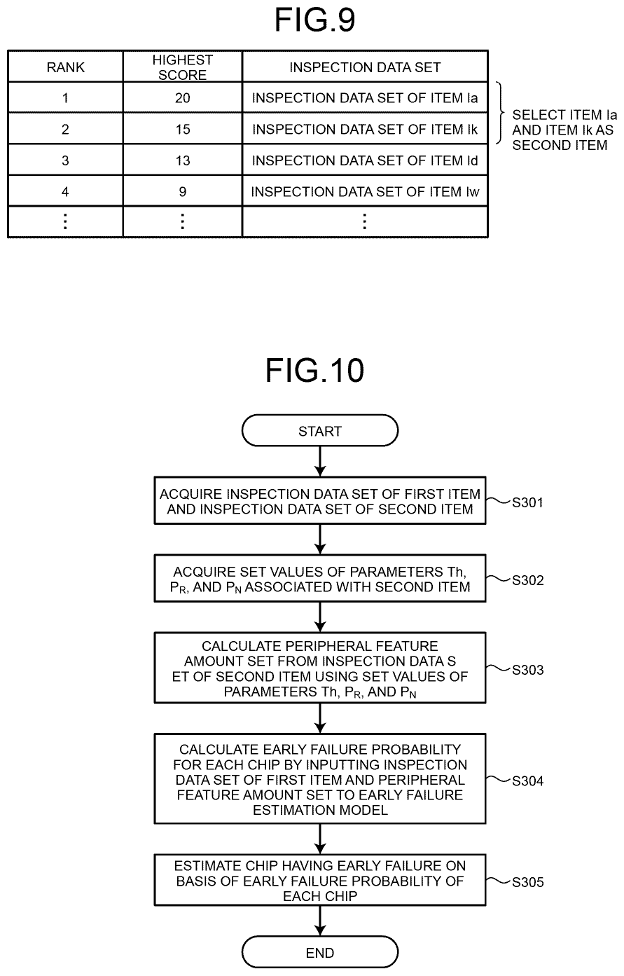

FIG. 9 is a table for describing a specific example of a determining method of a second item according to the embodiment. In the example illustrated in FIG. 9, the highest score of an inspection data set of item Ia is 20 points, which is the highest, the highest score of an inspection data set of item Ik is 15 points, which is the second highest, the highest score of an inspection data set of item Id is 13 points, which is the third highest, and the highest score of an inspection data set of item Iw is 9 points, which is the fourth highest.

In a case where the number of second items is set to two, the CPU 10 selects item Ia and item Ik as items whose highest scores are the highest and the second highest and determines each of item Ia and item Ik as a second item.

The CPU 10 determines a candidate value set corresponding to the time when the highest score is obtained for the inspection data set of item Ia, as the final setting values for the parameters Th, P_{N}, and P_{R} with respect to item Ia. The CPU 10 determines a candidate value set corresponding to the time when the highest score is obtained for the inspection data set of item Ik, as the final setting values for the parameters Th, P_{N}, and P_{R} with respect to item Ik.

The description will be made by referring back to FIG. 7. Subsequent to the processing of S111, the CPU 10 calculates a peripheral feature amount set from the inspection data set of the second items (S112). The CPU 10 acquires the peripheral feature amount set by executing the processing of S1 to S4 by using the final setting values of the parameters Th, P_{N}, and P_{R}.

Subsequently, the CPU 10 generates the early failure estimation model 100 by performing training using, as input data, the inspection data set of the first item and the peripheral feature amount set, and using the early failure label set as correct answer data (S113).

The CPU 10 outputs the generated early failure estimation model 100 to the RAM 12, the storage device 11, an external device, etc. (S114), whereby the operation of generating the early failure estimation model 100 according to the model generation program 20 ends.

FIG. 10 is a flowchart illustrating an example of an operation of estimating a chip CP with early failure according to the embodiment. Each piece of processing illustrated in this flowchart is implemented by the CPU 10 executing the early failure estimation program 21.

The CPU 10 acquires an inspection data set of a first item related to a wafer WF to be determined and an inspection data set of a second item related to the wafer WF to be determined (S301).

The CPU 10 acquires setting values of the parameters Th, P_{N}, and P_{R} associated with the second item (namely, acquires the final setting values determined in the processing of S111) (S302).

The CPU 10 calculates a peripheral feature amount set from the inspection data set of the second item (S303). The CPU 10 acquires the peripheral feature amount set by executing the processing of S1 to S4 by using the setting values of the parameters Th, P_{N}, and P_{R}.

The CPU 10 calculates the early failure probability for each chip CP by inputting the inspection data set of the first item and the peripheral feature amount set to the early failure estimation model 100 (S304).

Then, the CPU 10 estimates a chip CP with early failure on the basis of the early failure probability for each chip CP (S305). In one example, the CPU 10 estimates a chip CP with early failure by comparing the early failure probability with a predetermined threshold value. More specifically, the CPU 10 estimates that a chip CP whose early failure probability is higher than a predetermined threshold value Th3 is a chip CP with early failure. The CPU 10 estimates that a chip CP whose early failure probability is lower than the threshold value Th3 is a chip CP with no early failure. Note that the method of estimation based on the early failure probability is not limited to this. After the processing of S305, the operation of determining a chip CP with early failure ends.

As described above, according to the embodiment, the CPU 10 acquires the inspection data sets and the early failure label set (for example, S101 in FIG. 7). The CPU 10 determines a defective cluster, namely, a cluster of chips not satisfying the criterion for a non-defective product, on the basis of the inspection data sets (for example, S112 in FIG. 7 and S1 to S2 in FIG. 2). The CPU 10 calculates a peripheral feature amount set, which is a set of feature amounts for chips CP regarding the distance to the defective cluster (for example, S112 in FIG. 7 and S3 to S4 in FIG. 3). The CPU 10 executes training by using the inspection data sets and the peripheral feature amount set are used as input data, and using the early failure label set is used as correct answer data, on the machine learning model (for example, S113 in FIG. 7). Then, the CPU 10 outputs the early failure estimation model 100 that is a machine learning model of which the training has been performed.

Therefore, it is possible to accurately estimate a chip CP with early failure.

In addition, according to the embodiment, a state that a chip CP does not satisfy the criterion for a non-defective product means that the inspection data is worse than the binarization threshold value Th (for example, see S1 in FIG. 2). The CPU 10 executes the score calculation operation multiple times by varying values of the binarization threshold value Th and the parameters P_{N} and P_{R} (for example, S103 to S106 in FIG. 7). In the score calculation operation, the CPU 10 determines a group of defective chips (referred to as a first group) on the basis of a candidate value for the binarization threshold value Th (for example, S201 in FIG. 8) and determines a defective cluster on the basis of the first group and candidate values for the parameters P_{N} and P_{R} (for example, S202 in FIG. 8). In the score calculation operation, the CPU 10 further determines a group of first adjacent chips (referred to as a second group) and a group of third non-defective chips (referred to as a third group). In the score calculation operation, the CPU 10 further calculates the score SC based on the number of chips with early failure included in the second group and the number of chips CP with early failure included in the third group. The CPU 10 determines values of the binarization threshold value Th and the parameters P_{N} and P_{R} with which the best score is obtained on the basis of the results of the multiple times of the score calculation operation (for example, S107 in FIG. 7) and sets the determined values as setting values of the binarization threshold value Th and the parameters P_{N} and P_{R} (for example, S111 in FIG. 7). Then, the CPU 10 determines a chip CP not satisfying the criterion for a non-defective product by using the setting values of the binarization threshold value Th and the parameters P_{N} and P_{R} (for example, S112 in FIG. 7 and S1 to S2 in FIG. 2).

Therefore, it is possible to set each values of the binarization threshold value Th and the parameters P_{N} and P_{R} in such a manner that the estimation accuracy becomes as high as possible.

In the embodiment, the CPU 10 calculates the score SC based on the difference between the ratio R1 and the ratio R2 and the ratio R3 and in the score calculation operation (see, for example, S204 in FIG. 8). The ratio R1 denotes a ratio of the number of chips with early failure included in the second group to the number of chips CP included in the second group. The ratio R2 denotes a ratio of the number of chips CP with early failure included in the third group to the number of chips CP included in the third group. The ratio R3 denotes a ratio of the number of chips CP with early failure included in the second group to the total number of chips CP with early failure.

Therefore, it is possible to determine the setting values of the binarization threshold value Th and the parameters P_{N} and P_{R} in such a manner as to balance a high yield rate and high screening performance with each other.

In the embodiment, the CPU 10 executes the score calculation operation multiple times for each of inspection data sets (for example, S102 to S110 in FIG. 7). The inspection data sets are each obtained by inspection of different items. The CPU 10 selects, as a second item, at least one item having the best score among best scores of items on the basis of the best score calculated for each of the inspection data sets (for example, S111 in FIG. 7 and FIG. 9). The CPU 10 determines a defective cluster and calculates a peripheral feature amount set on the basis of the inspection data set of the second item (for example, S112 in FIG. 7, S1 to S2 in FIG. 2, and S3 to S4 in FIG. 3).

Therefore, it is possible to select an inspection data set with which the estimation accuracy can be enhanced from the inspection data sets as an inspection data set for calculation of the peripheral feature amount set.

In addition, according to the embodiment, in the score calculation operation, when the ratio of the number of third non-defective chips to the number of first adjacent chips is less than the threshold value Th1, the CPU 10 sets the value of the score SC to a value worse than the value calculated by the Equation (1) (for example, S205 and S207 in FIG. 8).

Therefore, in a case where the yield rate is expected to be extremely low, the evaluation value can be set to a worse value.

In addition, according to the embodiment, in the score calculation operation, when the ratio of the number of chips with early failure included in the group of first adjacent chips to the number of chips CP with early failure is less than the threshold value Th2, the CPU 10 sets the value of the score SC to a value worse than the value calculated by the Equation (1) (for example, S206 and S207 in FIG. 8).

Therefore, in a case where the screening performance is expected to be extremely low, the evaluation value can be set to a worse value.

In addition, according to the embodiment, the CPU 10 determines a defective cluster on the basis of inspection data sets (for example, S301 to S303 in FIG. 10 and S1 to S2 in FIG. 2). The CPU 10 calculates a peripheral feature amount set on the basis of the defective cluster (for example, S303 in FIG. 10 and S3 to S4 in FIG. 3). The CPU 10 acquires numerical information corresponding to the possibility that a chip CP has early failure by inputting the inspection data sets and the peripheral feature amount set to the trained early failure estimation model 100 configured to output the numerical information (for example, S304 in FIG. 10). Then, the CPU 10 estimates a chip CP with early failure on the basis of the numerical information (for example, S305 in FIG. 10).

Therefore, it is possible to accurately estimate a chip CP with early failure.

### (Modification)

The CPU 10 can execute various types of data processing on a peripheral feature amount set used for either training or estimation. As a modification of the embodiment, an example of processing that can be executed on a peripheral feature amount set will be described.

First, the CPU 10 calculates a peripheral feature amount set by the processing of S1 to S4 with respect to the inspection data set obtained by the first inspection of the second item. The CPU 10 executes data processing on this peripheral feature amount set.

In the modification, the CPU 10 performs averaging on the inspection data set obtained in the first inspection of the second item and multiplies the peripheral feature amount set by the averaged inspection data set.

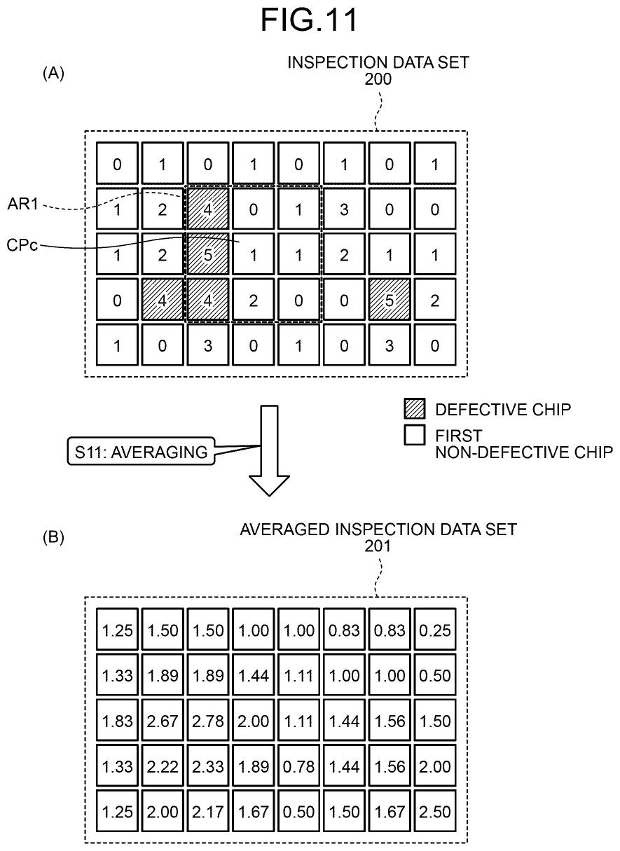

FIG. 11 is a diagram for explaining an averaging operation on an inspection data set according to the modification.

Part (A) of FIG. 11 illustrates an example of an inspection data set 200 obtained by the first inspection of the second item. Inspection data is indicated in a rectangle representing a chip CP. In addition, each chip CP determined to be a defective chip by the binarization threshold value Th is obliquely hatched.

The CPU 10 performs averaging on the inspection data set 200 (S11). The CPU 10 calculates an average value of the inspection data of all the chips CP included in a predetermined range centered on one chip CP and sets the average value as the averaged inspection data of the one chip CP.

In FIG. 11, as one example, a range of 3×3 chips is used for averaging. In a case of focusing on a chip CPc, the average value of inspection data of nine chips CP included in a range AR1 of the 3×3 chips centered on the chip CPc is applied as averaged inspection data of the chip CPc. The CPU 10 executes such processing on inspection data of all the chips CP.

An averaged inspection data set 201 illustrated in part (B) of FIG. 11 is obtained by the averaging processing.

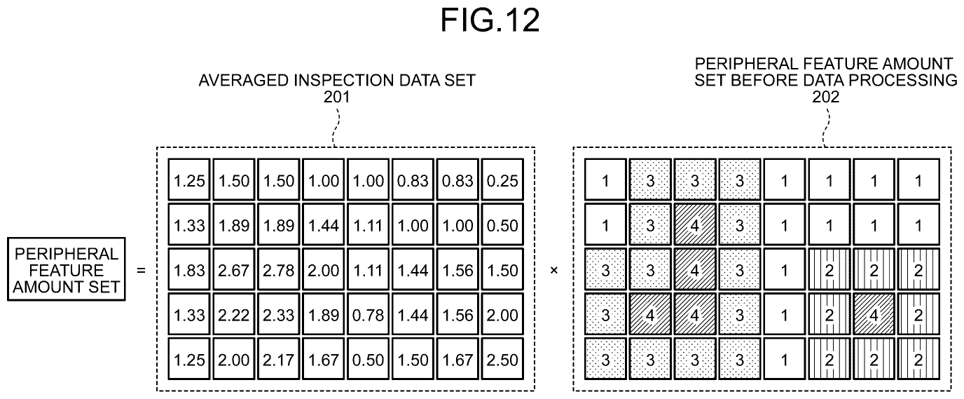

FIG. 12 is a diagram illustrating an example of processing of the peripheral feature amount set according to the modification. As illustrated in the drawing, the CPU 10 acquires the peripheral feature amount set after data processing by multiplying a peripheral feature amount set 202 before data processing by the averaged inspection data set 201.

As described above, according to the modification, the peripheral feature amount set after data processing is used for generation of the early failure estimation model 100 and estimation by the early failure estimation model 100.

Note that, in the modification, data processing of multiplying the peripheral feature amount set 202 by the averaged inspection data set 201 is executed. An example of the data processing is not limited to the above. For example, the CPU 10 may multiply the peripheral feature amount set 202 by the inspection data set 200 that is not averaged.

### (Other Modifications)

The score calculation method in the score calculation operation can be variously modified.

In one example, the CPU 10 constructs a machine learning model based on a decision tree algorithm in addition to the early failure estimation model 100. Then, the CPU 10 can use the importance of an explanatory variable as the score SC.

In another example, the CPU 10 constructs a machine learning model in addition to the early failure estimation model 100. Then, the CPU 10 can use Shapley Additive Explanation (SHAP) values of the machine learning model as the score SC.

In still another example, the CPU 10 can use a receiver operating characteristic area under curve (ROCAUC) at the time of defect prediction by one peripheral feature amount set as the score SC.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
a processor configured to:
acquire a first data set and a second data set, the first data set being a set of inspection results for multiple chips formed on a wafer or cut out from the wafer, the inspection results being obtained by executing a first inspection on the multiple chips, the second data set indicating, for each of the multiple chips, presence or absence of early failure obtained by executing a second inspection on the multiple chips;
determine, based on the first data set, a cluster of chips not satisfying a first criterion out of the multiple chips;
calculate a third data set being a set of feature amounts of chips related to a distance to the cluster;
execute training of a machine learning model by using, as input data, the first data set and the third data set and using the second data set as correct answer data; and
output the machine learning model of which the training has been executed.

2. The information processing device according to claim 1, wherein
the cluster of chips not satisfying the first criterion is a cluster of chips each of whose value of the inspection result is worse than a first threshold value, and
the processor is further configured to:
execute a score calculation operation multiple times while varying a second threshold value and a parameter value for clustering, the score calculation operation being executed by
determining a first group being a group of chips each of whose value of the inspection result is worse than the second threshold value,
determining, based on the first group and the parameter value, a cluster of chips each of whose value of the inspection result is worse than the second threshold value,
determining a second group and a third group, the second group being a group of chips adjacent to the cluster among the multiple chips, the third group being a group of chips each of whose value of the inspection result is better than the second threshold value among the multiple chips and being a group of chips not included in the second group, and
calculating a score based on the number of chips with early failure included in the second group and the number of chips with early failure included in the third group;
determine the second threshold value and the parameter value with which a best score is obtained on the basis of results of the multiple times of the score calculation operation;
set the determined second threshold value as the first threshold value; and
determine the cluster of the chips not satisfying the first criterion by using the determined parameter value.

3. The information processing device according to claim 2, wherein the processor is configured to calculate the score by the score calculation operation on the basis of
a difference between a first ratio and a second ratio, the first ratio being a ratio of the number of chips with early failure included in the second group to the number of chips included in the second group, the second ratio being a ratio of the number of chips with early failure included in the third group to the number of chips included in the third group, and
a ratio of the number of chips with early failure included in the second group to a total number of chips with early failure.

4. The information processing device according to claim 2, wherein
the first inspection includes inspection of multiple items,
the first data set includes fourth data sets obtained by inspection of different items in the inspection of the multiple items,
each of the fourth data sets is a set of inspection results for each chip obtained by inspection of one of the multiple items, and
the processor is further configured to:
execute the multiple times of the score calculation operations for each of the fourth data sets and calculate a best score for each of the fourth data sets;
select, from among the multiple items, at least one item whose best score is best among the fourth data sets; and
determine a cluster of chips not satisfying the first criterion and calculate the third data set, on the basis of the fourth data set corresponding to the selected at least one item.

5. The information processing device according to claim 3, wherein the processor is configured to set a value of the score to a value worse than a calculated value, in a case where a ratio of the number of chips included in the third group to the number of chips included in the second group is less than a third threshold value in the score calculation operation.

6. The information processing device according to claim 3, wherein the processor is configured to set a value of the score to a value worse than a calculated value, in a case where a ratio of the number of chips with early failure included in the second group to the number of chips with early failure among the multiple chips is less than a fourth threshold value in the score calculation operation.

7. An information processing device comprising
a processor configured to:
determine a cluster of chips not satisfying a first criterion on the basis of a first data set being a set of inspection results for multiple chips formed on a wafer or cut out from the wafer, the inspection results being obtained by executing a first inspection on the multiple chips;
calculate a second data set being a set of feature amounts of chips related to a distance to the cluster;
acquire numerical information corresponding to a possibility that a chip has early failure by inputting the first data set and the second data set to a trained machine learning model configured to output the numerical information; and
estimate a chip with early failure on the basis of the numerical information.

8. A method comprising:
acquiring a first data set and a second data set, the first data set being a set of inspection results for multiple chips formed on a wafer or cut out from the wafer, the inspection results being obtained by executing a first inspection on the multiple chips, the second data set indicating, for each of the multiple chips, presence or absence of early failure obtained by executing a second inspection on the multiple chips;
determining, based on the first data set, a cluster of chips not satisfying a first criterion out of the multiple chips;
calculating a third data set being a set of feature amounts of chips related to a distance to the cluster; and
executing training of a machine learning model by using, as input data, the first data set and the third data set and using the second data set as correct answer data.

9. The method according to claim 8, wherein
the cluster of chips not satisfying the first criterion is a cluster of chips each of whose value of the inspection result is worse than a first threshold value, and
the method further comprises:
executing a score calculation operation multiple times while varying a second threshold value and a parameter value for clustering, the score calculation operation being executed by
determining a first group being a group of chips each of whose value of the inspection result is worse than the second threshold value,
determining, based on the first group and the parameter value, a cluster of chips each of whose value of the inspection result is worse than the second threshold value,
determining a second group and a third group, the second group being a group of chips adjacent to the cluster among the multiple chips, the third group being a group of chips each of whose value of the inspection result is better than the second threshold value among the multiple chips and being a group of chips not included in the second group, and
calculating a score based on the number of chips with early failure included in the second group and the number of chips with early failure included in the third group;
determining the second threshold value and the parameter value with which a best score is obtained on the basis of results of the multiple times of the score calculation operation;
setting the determined second threshold value as the first threshold value; and
determining the cluster of the chips not satisfying the first criterion by using the determined parameter value.

10. The method according to claim 9, wherein the score calculation operation includes calculating a score based on
a difference between a first ratio and a second ratio, the first ratio being a ratio of the number of chips with early failure included in the second group to the number of chips included in the second group, the second ratio being a ratio of the number of chips with early failure included in the third group to the number of chips included in the third group, and
a ratio of the number of chips with early failure included in the second group to a total number of chips with early failure.

11. The method according to claim 9, wherein
the first inspection includes inspection of multiple items,
the first data set includes fourth data sets obtained by inspection of different items in the inspection of the multiple items,
each of the fourth data sets is a set of inspection results for each chip obtained by inspection of one of the multiple items, and
the method further comprises:
executing the multiple times of the score calculation operations for each of the fourth data sets and calculate a best score for each of the fourth data sets;
selecting, from among the multiple items, at least one item whose best score is best among the fourth data sets; and
determining a cluster of chips not satisfying the first criterion and calculate the third data set, on the basis of the fourth data set corresponding to the selected at least one item.

12. The method according to claim 10, wherein the score calculation operation includes setting a value of the score to a value worse than a calculated value, in response to determining that a ratio of the number of chips included in the third group to the number of chips included in the second group is less than a third threshold value.

13. The method according to claim 10, wherein the score calculation operation includes setting a value of the score to a value worse than a calculated value, in response to determining that a ratio of the number of chips with early failure included in the second group to the number of chips with early failure among the multiple chips is less than a fourth threshold value.

14. A method comprising:
determining a cluster of chips not satisfying a first criterion on the basis of a first data set being a set of inspection results for multiple chips formed on a wafer or cut out from the wafer, the inspection results being obtained by executing a first inspection on the multiple chips;
calculating a second data set being a set of feature amounts of chips related to a distance to the cluster;
acquiring numerical information corresponding to a possibility that a chip has early failure by inputting the first data set and the second data set to a trained machine learning model configured to output the numerical information; and
estimating a chip with early failure on the basis of the numerical information.
